(19) United States
(12) Patent Application Publication
(10) Pub. No.: US 2004/0234671 A1
(43) Pub. Date: Nov. 25, 2004

(54) Method and system for processing muscadine grape pomace

(76) Inventors: Betty J. Houston Ector, Starkville, MS (US); Jerry E. Mason, Florahome, FL (US)

Correspondence Address: Matthew W. Baca, Rogers Towers, P.A., Suite 1500, 1301 Riverplace Boulevard, Jacksonville, FL, 32207, US

(21) Appl. No.: 10/441,394

(22) Filed: May 20, 2003

(51) Int. Cl. A23K 1/00

(52) U.S. Cl. 426/615

(57) ABSTRACT

A method and system for processing muscadine grapes. In accordance with one embodiment, the method includes separating and removing naturally contained juice and sugars from muscadine grapes to produce a substantially dejuiced pomace. Next, a low-sugar liquid is added to the dejuiced pomace to obtain a low-sugar pomace mixture that is heated within a substantially sealed, pressurized vessel to produce tenderized pomace and pomace mixture liquid containing antioxidants leached from the dejuiced pomace. A portion of the heat treated pomace mixture liquid is removed and subsequently processed to extract antioxidant compounds therefrom. The remaining tenderized pomace mixture is processed into a puree that can be utilized for various food products.

This application claims the benefit of the U.S. Provisional Application Ser. No. ______ (Not yet assigned) filed on Apr. 24, 2003 entitled “METHOD AND SYSTEM FOR PROCESSING MUSCADINE GRAPE POMACE.”

### BACKGROUND OF THE INVENTION

1. Technical Field

The present invention relates generally to processing of natural food products and in particular to processing grapes and grape by-products. More particularly, the present invention relates to a method and system for processing muscadine grape pomace.

2. Description of the Related Art

The muscadine (Vitis rotundifolia) is a thick-skinned grape that is native to the southeastern United States. Due to its resistance to disease and insects, the muscadine is relatively easy to grow and has a high yield, averaging about 8-12 tons of grapes per acre. With the increased popularity of muscadine juice and rapid development of the muscadine industry, the demands for this fruit continue to increase.

The skins, seeds, and pulp left in the press following juice extraction, collectively referred to herein as “pomace,” have traditionally been considered as waste. Although specialized enzyme screening, cryogenic treatments, and other procedures have been used to increase juice yield, the thicker skins and larger seeds characteristic of muscadines results in substantially more waste associated with producing muscadine juice than most other types of grape juices or wines. For each ton of muscadines made into juice, almost 1000 pounds of pomace becomes a waste product. The pomace has long been utilized to a limited degree as fertilizer and as feed for some domestic animals, but in most cases the pomace has created a disposal problem. In recent years, research by Dr. Betty Ector of Mississippi State University and others has uncovered a variety of health-related benefits that may be derived from human consumption of food products derived from muscadine pomace. For example, it has been determined that the nutritional benefits of consumption of muscadine-pulp-derived foodstuffs include substantial dietary fiber, high concentrations of several vital minerals and vitamins. In addition, it has been found that muscadine pomace contains particularly high concentrations of the phenolic compounds, including phytoalexin resveratrol (“resveratrol”) and ellagic acid having antioxidant and tumor inhibition properties.

In view of these discovered benefits, considerable research and development are being devoted to finding improved techniques for processing muscadine pomace into human consumable food products and concentrated extracts. One such effort described in U.S. Pat. No. 6,190,716, issued to Galbreath, entails breaking down the pulp of the crushed and dejuiced muscadines through heating the pomace and enzymatic action over a specified period. The method disclosed by Galbreath is a tri-parte process having three parallel series of steps including: dejuicing and drying a first portion of the pomace; dejuicing, heating, enzymatically treating, extruding, and drying a second portion of the pomace; and blending the resulting dried product from these two steps with a fermented, pressed and dried portion of the grapes. Although purporting to result in a dried combined product that is readily digestible and contains high levels of resveratrol, ellagic acid and other phenolic compounds and antioxidants, the process and system required to implement the foregoing method adds significant complexity and delay in muscadine processing.

It can therefore be appreciated that a need exists for a more efficient method and system for processing muscadine grapes in which antioxidants such as resveratrol and ellagic acid are optimally preserved and maintained as a non-dried food product and concentrated extract. The present invention addresses such a need.

### SUMMARY OF THE INVENTION

A method and system for processing muscadine grapes are disclosed herein. In accordance with one embodiment, the method includes separating and removing naturally contained juice and sugars from muscadine grapes to produce a substantially dejuiced pomace. Next, a low-sugar liquid is added to the dejuiced pomace to obtain a low-sugar pomace mixture that is heated within a substantially sealed, pressurized vessel to produce tenderized pomace and pomace mixture liquid containing antioxidants leached from the dejuiced pomace. A portion of the heat treated pomace mixture liquid is removed and subsequently processed to extract antioxidant compounds therefrom. The remaining tenderized pomace mixture is processed into a puree that can be utilized for various food products.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts a block diagram system for processing muscadine grapes in accordance with a preferred embodiment of the present invention; and

FIG. 2 is a flow diagram illustrating steps for processing muscadine grapes in accordance with a preferred embodiment of the present invention.

### DETAILED DESCRIPTION OF A PREFERRED EMBODIMENT

This invention is described in a preferred embodiment in the following description with reference to the figures. While this invention is described in terms of the best mode for achieving this invention's objectives, it will be appreciated by those skilled in the art that variations may be accomplished in view of these teachings without deviating from the spirit or scope of the present invention.

The present invention is directed to processing muscadine grapes, and more specifically to efficiently processing muscadine pomace into human consumable food products and extract concentrates that contain resveratrol, ellagic acid and other compounds which have been shown to exhibit antioxidant and tumor inhibition properties. Furthermore, the method and system of the present invention addresses problems associated with conventional muscadine processing techniques relating to dissipation or decomposition of antioxidant compounds. Specifically, antioxidant compounds including resveratrol and ellagic acid occurring in muscadine pomace, have been discovered to decompose when heated under pressure in a high-sugar content solution. The present invention provides a means for obtaining high antioxidant yield without the need to use additive enzymes by strategically removing the high-sugar content muscadine juice and supplying a replacement low-sugar content liquid within which the muscadine pomace is heated under pressure. Furthermore, heating the pomace and low-sugar content liquid under pressurized conditions significantly improves the efficiency of muscadine processing by reducing the time required to process muscadine pomace. In this manner, the method and system of the present invention provides an efficient means by which muscadine grape pomace is processed over a relatively brief period and in a manner that optimally preserves valuable constituents of muscadine pomace.

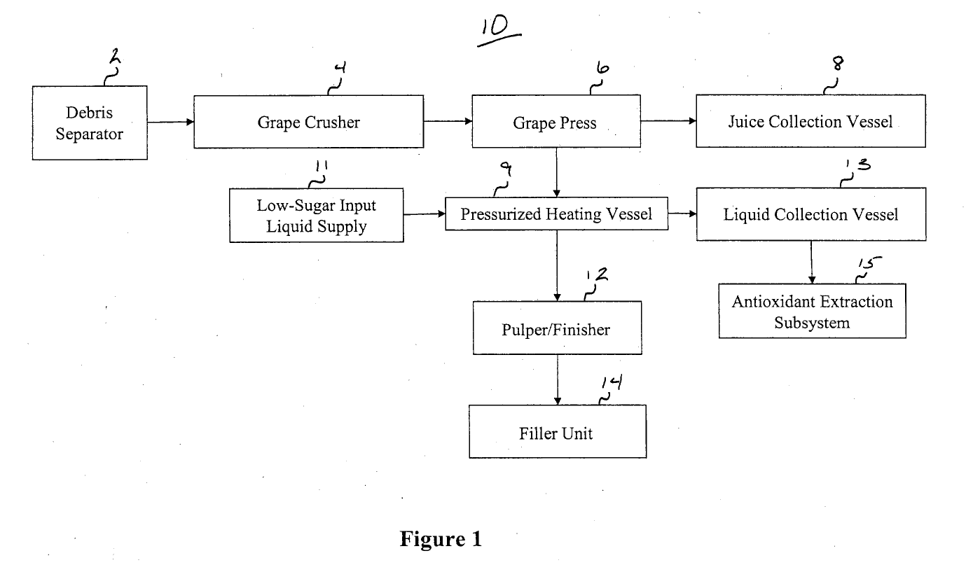

With reference now to the figures, wherein like reference numerals refer to like and corresponding parts throughout, and in particular with reference to FIG. 1, there is depicted a block diagram of a pomace processing system 10 for processing muscadine grapes in accordance with a preferred embodiment of the present invention. As utilized herein, “muscadine grapes” refer to the grape genus/species vitis rotundifolia. Muscadines processed in accordance with the techniques disclosed herein may fall into different categories or cultivars. For example the “bronze-skinned” cultivars are identified by those skilled in the art as including Carlos, Chowan, Doreen, Higgins, Magnolia, Nevermiss, Pamlico, Roanoke, Scuppernong, Sterling, and Summit cultivars. The “dark-skinned” cultivars include Albermarle, Bountiful, Cowart, GA-1, Hunt, NC-1, Noble, Regale, Tarheel, and Jumbo. Although there are some differences in properties between the various muscadine cultivars, all muscadines share certain morphological and compositional characteristics that are distinct from other types of grapes. Specifically, the common distinctive characteristics of muscadines include a thick, tough skin, a relatively large seed, and a particularly high naturally occurring sugar content.

As shown in FIG. 1, pomace processing system 10 includes a debris separator 2 for separating and removing debris such as leaves, branches, stems, etc., from an input batch of muscadine grapes (not depicted). Given the characteristic thickness and toughness of muscadine grape skins, the grape skins are preferably pierced or crushed prior to juice removal. To this end, and following separation and removal of the debris, the grapes are delivered to a press preparation device, or “crusher” 4, which pierces or otherwise breaches the thick skins characteristic of muscadine grapes in preparation for subsequent pressing. A grape press 6 is then utilized to press and separate the muscadine juice from the muscadine pomace. A variety of devices well-known to those skilled in the art may be utilized as debris separator 2, crusher 4, and grape press 6.

The pressing of the grapes within grape press 6, results in a mixture of muscadine grape pomace (not depicted) together with the pressed grape juice. The naturally occurring juice carried by muscadine grapes is characterized by a concentration of sugar much higher than that found in other types of grapes. It has been found by the inventor that this particularly high sugar content, when maintained and heated together with the muscadine pomace, has a detrimental effect on various nutritionally valuable constituents of muscadine pomace. Therefore, prior to being heat-treated, the high sugar content muscadine juice is removed and collected within a juice collection vessel 8. After substantial removal of the muscadine juice, the remaining muscadine pomace, comprising the skins, pulp and seeds, is delivered to a pressurized heating vessel 9.

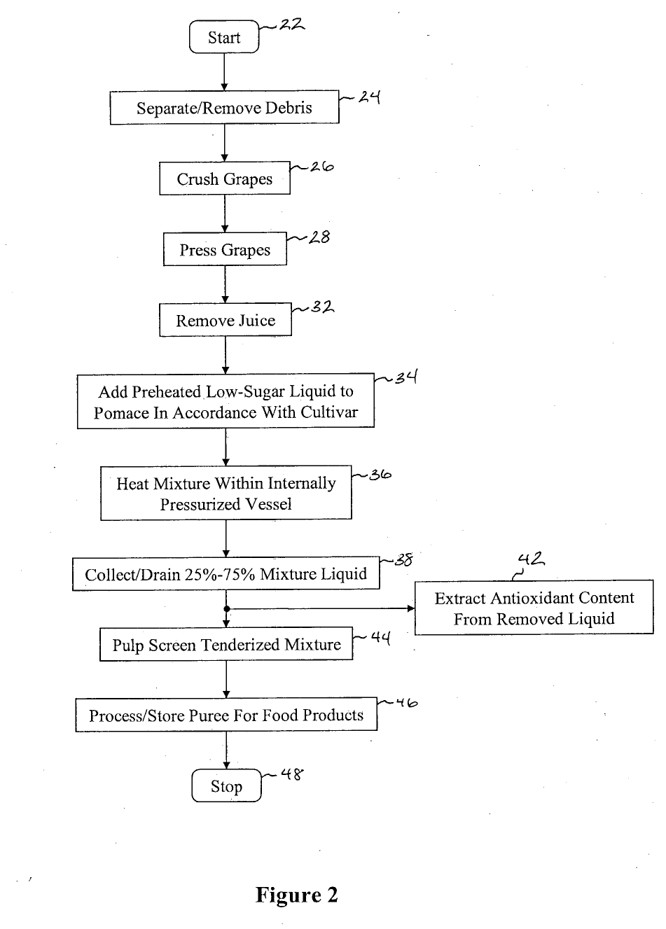

As further explained with reference to FIG. 2, a liquid input supply 11 is utilized to add an amount of water or other suitable low-sugar liquid to the dejuiced muscadine pomace within pressurized heating vessel 9 prior to the pomace being heat treated. As utilized herein, “low-sugar liquid” refers to liquids having very low, and therefore materially insignificant concentration of any of the various water-soluble sugar compounds including sucrose that occurs naturally in most plants. The pressurized heating of the resulting low-sugar liquid/pomace mixture greatly increases the time and energy efficiency of the process of tenderizing the pomace. Furthermore, pressurized heating vessel 9, being substantially sealed to maintain a positive internal pressure, prevents the escape of volatile nutritional components as they are heat extracted from the pomace and leach into the mixture fluid during the pressurized heating process. In accordance with a preferred embodiment, pressurized heating vessel 9 is a steam jacketed internal pressurized kettle that includes “agitator” or “scraper” means (not depicted) for mixing or stirring the pomace/liquid mixture to ensure even heat distribution throughout the mixture.

A range of suitable temperature and pressure combinations may be utilized to process the reconstituted pomace mixture within pressurized heating vessel 9 until the pomace is sufficiently tenderized and ready for subsequent processing into puree. In an important feature of the present invention, a portion of the liquid component of the tenderized pomace mixture within pressurized heating vessel 9 is removed by a vacuum pump or other suitable liquid removal means (not depicted) and transferred to a liquid collection vessel 13. The remaining pomace mixture is delivered from pressurized heating vessel 9 to a pulper-finisher device 12, which includes paddles and a screen or series of screens (not depicted) for obtaining a desired puree consistency of predetermined texture and fluidity. The puree is then delivered to a filler unit subsystem 14 where the puree is diverted and sealed into standard food-grade containment vessels for subsequent distribution.

The liquid component removed after pressurized heating is delivered from pomace mixture liquid collection vessel 13 to an antioxidant extraction subsystem 15 that includes functionality for concentrating the antioxidant content of the liquid. From among the several known techniques for achieving an antioxidant-rich extract from the liquid, antioxidant extraction subsystem 15 may comprise functionality for either partially freeze drying the pomace liquid or heating the liquid to attain the desired concentration of antioxidant compounds.

Referring now to FIG. 2, there is depicted a flow diagram illustrating steps undertaken for processing muscadine grapes in accordance with a preferred embodiment of the present invention. As shown in FIG. 2, the process begins at step 22 and proceeds to step 24 with the separation and removal of sticks, leaf clusters, stems and other debris from a batch of muscadine grapes within debris separator 2. Next, as depicted at steps 26 and 28, the grapes are crushed and pressed by crusher 4 and grape press 6, respectively, to remove a majority of the grapes' natural high-sugar content juices. Following removal of the muscadine juice (step 32), a specified quantity of a low-sugar liquid such as water is added to the dejuiced pomace as illustrated at step 34. The resulting mixture has a dramatically lower sugar content than the original pressed pomace/muscadine juice mixture, and will be referred to herein as a “low-sugar pomace mixture.” To maintain a relatively even thermal gradient within pressurized heating vessel 9 over a series of heating cycles, the added liquid is preferably preheated to at or near 212° F.

The added water serves a dual purpose in providing a desirable thermal transfer medium as well as a forum for collecting antioxidants from the nutrient-rich muscadine pomace that leach from the pomace during the subsequent pressurized heating step. Although some sugar content remains in the dejuiced muscadine pomace, the removal of muscadine juice at step 32, and effective dilution of the residual sugar content by the added water, results in a particularly well-suited pomace liquid composition that reduces the breakdown of valuable antioxidant content of the dejuiced pomace. The amount of water added to the dejuiced pomace depends on the amount (in terms of weight) and cultivar type of the object batch of muscadine grapes. For example, some cultivars are characteristically “dry” having characteristically lower residual juice content in the dejuiced pomace, and therefore require a correspondingly greater amount of mixture water, while other cultivars have a higher residual juice content and conversely require less added water per unit weight. To achieve the desired relative mixture, 1 part water is added to 1 to 4 parts pomace (by weight) depending on the “dryness” of the object cultivar.

Proceeding to step 36, the dejuiced pomace/water mixture is heated under pressure within pressurized heating vessel 9 at a specified temperature and pressure until the pomace has been sufficiently tenderized and the antioxidant content resident within the skins, pulp, and seeds of the pomace have sufficiently leached into the mixture liquid. Pressurized heating of the pomace/water mixture greatly reduces the overall time and energy requirements for achieving the requisite tenderization and antioxidant extraction from the pomace as compared with non-pressurized heating. In a preferred embodiment, the pomace mixture is heated within pressurized heating vessel 9 at pressure/temperature combinations ranging from 240° F. at 10 psi to 281° F. at 35 psi. The period over which the pomace mixture is heated depends on both the cooking temperature/pressure as well as the quantity of the pomace mixture. Assuming, for example, a 150 gallon quantity of pomace mixture within pressurized heating vessel 9, the mixture will be processed under the foregoing temperatures/pressures from between 10 minutes, for the higher end temperatures/pressures, to 25 minutes for the lower end temperatures/pressures.

Following the pressurized heating of the pomace mixture, a specified quantity of the mixture liquid is drained or otherwise separated and removed from the pomace as depicted at step 38. Preferably, 25% to 75% of the liquid content of the tenderized pomace mixture is collected within collection vessel 13 from where it is delivered to antioxidant extraction subsystem 15 where the water-soluble antioxidant content that leached from the pomace into the mixture liquid during heating step 36 is removed by one of a variety of known extraction techniques as illustrated at step 42. Such extract from muscadine pomace will include significant quantities of resveratrol, ellagic acid and other polyphenolics, which have been shown to exhibit antioxidant and tumor inhibition properties. In addition, such extracted antioxidant compounds have been found to include the property of stabilizing muscadine color pigment and can therefore be subsequently utilized as color-stabilizing supplement for food or drink products derived from muscadine juice. As explained with reference to FIG. 1, the condensation/extraction of the desired antioxidant compounds may be achieved by a variety of known techniques. In one embodiment, the antioxidant content is extracted from the removed pomace liquid by an evaporation/condensation technique (i.e. heating) to obtain an antioxidant-rich extract. In an alternative embodiment, such antioxidant extraction is achieved by partially freeze drying the removed pomace liquid to separate out the antioxidant compounds.

The dejuiced and cooked pomace remaining in pressurized heating vessel 9 after the pomace mixture liquid has been removed retains significant concentrations of antioxidants and other nutrients and is further processed into human-consumable food products as illustrated at steps 44 and 46. First, as depicted at step 44 the pomace is delivered to pulper device 12 where the pulpable skin and pulp constituents are processed into a puree and the seeds are screened out and either delivered for specialized processing or are discarded. Optionally, step 44 may entail adding water prior to or during the pulping/screening process and a 0.033-inch to 0.060-inch mesh screen or series of screens is utilized to yield a puree having a desired granularity and fluid consistency. Next, as depicted at step 46 the puree, which is maintained at a suitable sterilization temperature of between 190° F. and 212° F. is delivered to filler unit 14 where the puree is diverted to and sealed within standard food-grade containment vessels. In this form, the puree may be maintained for long periods of time at ambient or low temperatures (approximately −4° F.) and is readily utilized as or incorporated into a variety of human consumable foodstuffs. The muscadine processing method then terminates as shown at step 48.

While this invention has been described in terms of several embodiments, it is contemplated that alterations, permutations, and equivalents thereof will become apparent to one of ordinary skill in the art upon reading this specification in view of the drawings supplied herewith. It is therefore intended that the invention and any claims related thereto include all such alterations, permutations, and equivalents that are encompassed by the spirit and scope of this invention.

What is claimed is:

1. A method for processing muscadine grapes comprising:
separating and removing naturally contained juice and sugars from muscadine grapes to produce a substantially dejuiced pomace;
adding a low-sugar liquid to the dejuiced pomace to obtain a low-sugar pomace mixture; and
heating the low-sugar pomace mixture within a substantially sealed, pressurized vessel to produce tenderized pomace and pomace mixture liquid containing antioxidants leached from the dejuiced pomace.

2. The method of claim 1, wherein the low-sugar liquid is water.

3. The method of claim 1, further comprising separating a portion of the pomace mixture liquid from the tenderized pomace.

4. The method of claim 3, wherein the separated portion of the pomace mixture liquid comprises 25% to 75% of the pomace mixture liquid.

5. The method of claim 3, further comprising processing the tenderized pomace into a puree.

6. The method of claim 3, further comprising extracting antioxidant content from the separated pomace mixture liquid.

7. The method of claim 6, wherein said extracting antioxidant content from the separated pomace mixture liquid comprises freeze drying the separated pomace mixture liquid to obtain an antioxidant rich extract.

8. The method of claim 6, wherein said extracting antioxidant content from the separated pomace mixture liquid comprises evaporatively separating antioxidant content from the separated pomace mixture liquid to obtain an antioxidant rich extract.

9. The method of claim 6, wherein the extracted antioxidant content includes the property of stabilizing muscadine color pigment.

10. The method of claim 6, further comprising incorporating the extracted antioxidant content into human consumable food products or oral supplements.

11. The method of claim 1, wherein said adding a low-sugar liquid to the dejuiced pomace comprises adding a specified amount of preheated liquid to the dejuiced pomace to obtain the low-sugar pomace mixture at an elevated temperature.

12. The method of claim 11, wherein the specified amount of added preheated liquid is determined in accordance with the amount of dejuiced pomace and the cultivar of the muscadine grapes from which the dejuiced pomace was obtained.

13. A system for processing muscadine grapes comprising:
means for separating and removing naturally contained juice and sugars from muscadine grapes to produce a substantially dejuiced pomace;
means for adding a low-sugar liquid to the dejuiced pomace to obtain a low-sugar pomace mixture; and
a substantially sealed, pressurized vessel for heating the low-sugar pomace mixture under pressure to produce tenderized pomace and pomace mixture liquid containing antioxidants leached from the dejuiced pomace.

14. The system of claim 13, wherein the low-sugar liquid is water.

15. The system of claim 13, further comprising means for separating a portion of the pomace mixture liquid from the tenderized pomace.

16. The system of claim 15, wherein said means for separating a portion of the pomace mixture liquid from the tenderized pomace is a vacuum pump.

17. The system of claim 15, wherein the separated portion of the pomace mixture liquid comprises 25% to 75% of the pomace mixture liquid.

18. The system of claim 15, further comprising a pulper device for processing the tenderized pomace into a puree.

19. The system of claim 15, further comprising an antioxidant extraction subsystem for extracting antioxidant content from the separated pomace mixture liquid.

20. The system of claim 19, wherein said antioxidant extraction subsystem includes functionality for freeze drying the separated pomace mixture liquid to obtain an antioxidant rich extract.

21. The system of claim 19, wherein said antioxidant extraction subsystem includes functionality for evaporatively separating antioxidant content from the separated pomace mixture liquid to obtain an antioxidant rich extract.
